(19) United States
(12) Patent Application Publication
(10) Pub. No.: US 2022/0037724 A1
(43) Pub. Date: Feb. 3, 2022

(54) ELECTRICAL BATTERY AND ASSOCIATED VEHICLE

(71) Applicants: Faurecia Systemes D'Echappement, Nanterre (FR); Hutchinson, Paris (FR)

(72) Inventors: Quentin Provost, Cravanche (FR); Jean-Baptiste Cassard, Change (FR); Loïc De Francqueville, Montigny Sur Loing (FR); Engin Ertem, Amilly (FR)

(21) Appl. No.: 17/388,787

(22) Filed: Jul. 29, 2021

(30) Foreign Application Priority Data
Jul. 30, 2020 (FR) 2008086

(51) Int. Cl. H01M 50/209; B60L 50/64; B60L 58/26; H01M 50/249; H01M 10/6556; H01M 10/613; H01M 10/625

(52) U.S. Cl. CPC H01M 50/209; B60L 50/64; B60L 58/26; H01M 2220/20; H01M 10/6556; H01M 10/613; H01M 10/625; H01M 50/249

(57) ABSTRACT

This electrical battery according to the present disclosure may comprise a housing including a lower part and an upper part; a plurality of electricity storage cells arranged in the housing and intended to together form a source of electrical energy for the battery; and at least one docking member of the plurality of cells. Each docking member may define an interior volume. Further, each electricity storage cell may be arranged in the interior volume and may be attached to the housing by means of one of the or the docking member. Each docking member may extend transversely into the housing and covers at least one side face of each cell. Each docking member may have an opening to the interior volume so that the opening opens to an exposed face of each cell arranged in the interior volume.

### CROSS REFERENCE TO RELATED APPLICATIONS

This application claims priority to and the benefit of French Patent Application No.: 2008086, filed 30 Jul. 2020, the disclosure of which is now expressly incorporated herein by reference.

### FIELD OF THE DISCLOSURE

The present disclosure relates to a battery, in particular for a vehicle.

### BACKGROUND

An electrical battery usually has a housing with battery modules. Each battery module comprises electricity storage cells, and a closed casing protecting these electricity storage cells, in particular from the environment outside the battery. The modules contain all the cells in the battery. Such modules are, for example, intended to hold the electricity storage cells inside the battery housing in position.

It should be noted that a cell, for example an electrochemical cell, is an element capable of storing or releasing electrical energy from a chemical reaction. A cell generally provides an electrical potential of less than 5 volts. A module is an assembly of such elementary cells in a single closed casing. A battery is an assembly of such modules.

However, such electric batteries are not entirely satisfactory. Indeed, the manufacture and/or supply of battery modules is expensive, making the battery expensive as a whole. In addition, the weight of such a battery is usually significant.

One of the aims of the present disclosure is thus to propose an electrical battery, in particular for vehicles, in which the battery is lighter without reducing its power, and whose cost is reduced.

### SUMMARY

A battery according to the present disclosure may include a housing comprising a lower part and an upper part, a plurality of electricity storage cells, arranged in the housing and intended to together form a source of electrical energy for the battery, and at least one docking member of the plurality of cells. Each docking member defines an interior volume. Each electricity storage cell is arranged in the interior volume and is attached to the housing by means of one of the or the docking member. Such an electrical battery may be for example intended for a vehicle, in particular a motor vehicle.

In some embodiments, each docking member extends transversely into the housing and covers at least one side face of each electricity storage cell. Each docking member has an opening to the interior volume such that the opening opens onto an exposed face of each electricity storage cell arranged in the interior volume.

According to other aspects of the present disclosure, the electrical connection device comprises one or more of the following features taken in isolation or in any combination that is technically possible:
the docking member is formed by a beam or profile with a U-shaped cross-section;
the housing and/or the docking member are made of thermoplastic or thermosetting resin, which can be reinforced with chopped and/or continuous fibers;
the battery comprises at least one member for holding at least one electricity storage cell in the docking member, the at least one holding member comprising at least one locking element;
the battery comprises:
   a first holding member comprising a first support attached to the upper part, and a flexible first locking element extending between the first support and the exposed face of at least one electricity storage cell, to lock said electricity storage cell vertically in the housing, and/or
   a second holding member comprising a second support attached to the upper part, and a flexible second locking element extending between the second support and a side face of at least one electricity storage cell, to lock said electricity storage cell longitudinally in the housing, and/or
   a third holding member comprising a third support attached to the lower part and/or to the docking member, and a third locking element extending between the third support and a longitudinal face of at least one electricity storage cell, the longitudinal face extending substantially perpendicularly to the exposed and side faces, to lock said electricity storage cell laterally in the housing, and/or
   a fourth holding member comprising a fourth support attached to the lower part and/or to the docking member, and a fourth locking element extending between the longitudinal faces of two adjacent electricity storage cells, each longitudinal face extending substantially perpendicular to the exposed and side faces, to lock said electricity storage cells laterally;
the battery comprises a cooling circuit arranged in the interior volume between the side face of at least one electricity storage cell and the docking member;
the battery comprises a reinforcing profile, the reinforcing profile connecting the docking member to the lower part of the housing and holding the docking member away from the lower part of the housing;
the battery comprises a stacking region, with at least two electricity storage cells stacked between a lower plate of the lower part of the housing and an upper plate of the upper part of the housing in the stacking region, the battery comprising at least one intermediate plate disposed between the stacked electricity storage cells; and
the battery has at least one impact damper arranged outside the housing, the impact damper being connected to the housing opposite the lower plate and/or the upper plate and/or the intermediate plate.

The present disclosure further relates to a vehicle comprising an electrical battery as aforesaid.

The disclosure will be better understood upon reading the following description, given only as a non-limiting example.

### BRIEF DESCRIPTIONS OF THE DRAWINGS

FIG. 1 is a schematic depiction in exploded perspective view of a battery according to one embodiment of the present disclosure;

FIG. 2 is a schematic depiction in longitudinal section of a first detail of the battery of FIG. 1 when the battery is assembled; and

FIG. 3 is a schematic depiction in longitudinal section of a second detail of the battery of FIG. 1 when the battery is assembled.

### DETAILED DESCRIPTION

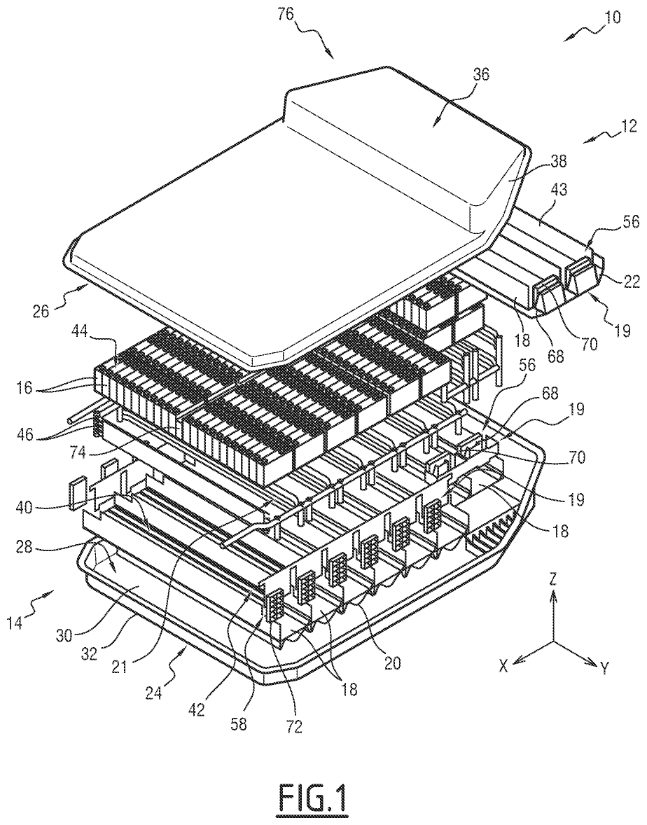

With reference to FIG. 1, a vehicle 10 comprises a battery 12. The vehicle 10 may be a motor vehicle. The vehicle 10 is, for instance, an electrically-powered vehicle.

The battery 12 is configured to at least partially supply the vehicle 10 with electrical energy. The battery 12 has, for example, an energy capacity of between 10 kwh and 30 kwh when the vehicle is a plug-in hybrid and between 30 kwh and 100 kwh when the vehicle is a purely electric vehicle. The battery 12 is for example configured to deliver a voltage of between 250 V and 420 V across its terminals. The nominal voltage of battery 12 is on the order of 400 V. In some variants, the nominal voltage of the battery is around 800 V.

The battery 12 is for example configured to supply electricity to a propulsion motor of the vehicle 10.

The battery 12 is for example arranged in a chassis of the vehicle 10, for example in the region of a lower body of the vehicle. In one particular embodiment, the battery 12 forms part of the chassis of the vehicle 10.

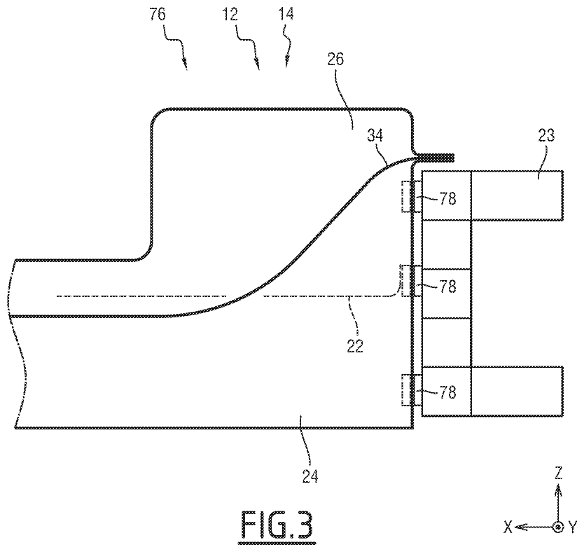

The battery 12 comprises a housing 14, a plurality of electricity storage cells 16 and at least one docking member 18 of the electricity storage cells 16. The battery 12, in some embodiments, further comprises at least one holding member 19, at least one reinforcing profile 20 and a cooling circuit 21. In a particular embodiment, the battery further comprises an intermediate plate 22 and an impact damper 23, as shown in FIG. 3.

The housing 14 comprises a lower part 24 and an upper part 26. The housing 14 defines a chamber 28 in which the electricity storage cells 16 and the docking unit 18 are arranged. The housing 14 is for example impermeable and the protection rating of the enclosure 14 according to IEC 60529 is greater than IP6X, where X is between one and seven, and is more particularly greater than IP67.

The housing 14 is, in some embodiments, formed from thermoplastic or thermosetting resin. In a first embodiment, the housing 14 comprises a matrix of fibres, such as carbon or glass fibres, embedded in a thermoplastic or thermoset matrix. The fibres are for example chopped fibres and/or continuous fibres, for example woven. The length of the chopped fibres is less than 10 mm and the length of the continuous fibres is greater than 10 mm.

In an alternative or complementary variant, the housing 14 comprises ferromagnetic elements, such as a metal mesh, embedded in the thermoplastic or thermosetting resin. Such elements ensure the electromagnetic shielding of the battery. The ferromagnetic elements are, for example, arranged between two fibre mats and are embedded in the resin.

The lower part 24 and the upper part 26 are for example connected by a metal belt (not shown), e.g. a clip-type metal belt. Alternatively or additionally, the lower part 24 and the upper part 26 comprise metal screws connecting the ferromagnetic elements. Such a belt or screws, connecting the lower part 24 and the upper part 26, ensure electrical continuity between the ferromagnetic elements of the lower part 24 and those the upper part 26 and can be advantageous for managing possible electromagnetic wave leakage.

The lower part 24 comprises for example a lower plate 30 and, in some embodiments, comprises a lower edge 32, as shown in FIG. 1. The lower part 24 then forms a basin-shaped bottom.

The lower plate 30 extends substantially in a plane substantially parallel to the longitudinal X and transverse Y directions.

The lower edges 32 extend around the lower plate 30 towards the upper part 26. In particular, the lower edges 32 are connected and fixed to the upper part 26 along a seam 34 connecting the lower part 24 to the upper part 26. The lower edges 32, in some embodiments, form a closed contour around the lower plate 30.

In a variant not shown, the lower part 24 is plate-shaped and has no lower edge 32.

The upper part 26 comprises an upper plate 36 and, in some embodiments, comprises an upper edge 38, as shown in FIG. 1. The upper part 26 then forms a bowl-shaped lid.

As seen in FIG. 1, the upper part 26 comprises for example several tiers, each tier extending in a plane substantially parallel to the longitudinal and transverse directions.

The upper edges 38 extend around the upper plate 36 towards the lower part 24. In particular, the upper edges 38 are connected and fixed to the lower part 24 along the seam 34. The upper edges 38, in some embodiments, form a closed contour around the upper plate 36.

In a variant not shown, the upper part 26 is plate-shaped and has no upper edge 38.

Each docking member 18 defines an interior volume 40. Each docking member 18 extends transversely into the housing 14. Each docking member 18 is, for example, connected to the lower edge 32 at each end.

Each docking member 18 has an opening 42 into the interior volume 40. Thus, each docking member 18 differs from a module of the state of the art in particular in that it does not comprise a closed casing.

Each docking member 18 covers at least one face of each electricity storage cell 16, and more particularly at least one side face of each electricity storage cell, as will be described in more detail below.

In the variant shown in FIGS. 1 to 3, the docking member 18 is formed by a beam or profile with a U-shaped cross-section. The legs of the U are formed by side walls 43. In this variant, the opening 42 corresponds to the opening formed between the ends of the legs of the U, the interior volume 40 being the volume between the legs of the U.

Preferably, the docking member 18 is formed from thermoplastic resin. The docking member 18 is for example formed from the same material as the housing 14.

Preferably, the docking member 18 is produced by a pultrusion process, and more particularly by pultrusion of composite material. In a particular embodiment not shown, the docking member 18 is formed in the lower part 24 and is for example derived from a co-moulding of the lower part 24 and the docking member 18. In other words, in this embodiment, the docking member 18 is made of material with the lower part 24.

The reinforcing profile 20 connects the docking member 18 to the lower part 24 of the housing 14. The reinforcing profile 20 keeps the docking member 18 away from the lower part 24 of the housing 14, and more particularly away from the lower plate 30.

The reinforcing profile 20 extends transversely into the housing 14. The reinforcing profile 20 extends substantially parallel to the docking member 18.

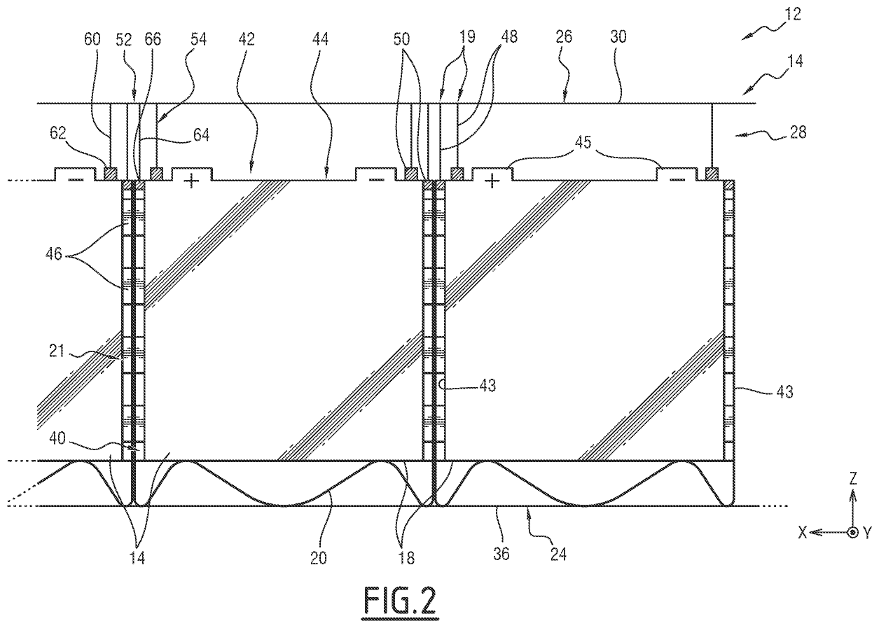

As can be seen in FIG. 2, the reinforcing section 20 is for example formed by a beam having an M-shaped cross-section. The reinforcing section 20 thus connects a region of the lower part 24 extending substantially opposite a middle region of the docking member 18, to lateral regions of the docking member 18, i.e. regions extending in front of or behind the middle region. As shown in FIG. 2, the vertices of the M forming the reinforcement profile 20 are connected to the base of the U forming the docking member 18, opposite the legs of the U.

Alternatively, the reinforcing profile 20 is a profile with a rectangular outer profile. Alternatively, the reinforcing profile 20 comprises at least two separate profile sections each connecting the lower part 24 to the docking member 18.

The reinforcement profile 20 is, in some embodiments, formed from thermoplastic resin. The reinforcement profile 20 is for example formed from the same material as the housing 14.

Preferably, the reinforcement profile 20 is produced by a pultrusion process, and more particularly by pultrusion of composite material. In a particular embodiment not shown, the reinforcement profile 20 is formed in the lower part 24 and is for example derived from a co-moulding of the lower part 24 and the reinforcement profile 20. In other words, in this variant, the reinforcement profile 20 is integrally formed with the lower part 24.

In one particular embodiment, the reinforcing profile 20 is integrally formed with the docking member 18. The reinforcing profile 20 and the docking member 18 form for example a single beam, the upper portion of which is U-shaped and the lower section of which is M-shaped. The profile of such a beam is for example shaped like a U atop an M. Alternatively, the base of the U is M-shaped.

Each electricity storage cell 16, hereinafter referred to as cell 16, comprises chemical elements for releasing electrical energy.

The plurality of cells 16 arranged in the housing 14 and the cells are intended to together form a source of electrical energy for the battery 12.

Each cell 16 has, for example, a capacity of between 60 Ah and 120 Ah, and is configured to define a voltage of between 2.5 V and 4.2 V across its terminals.

Each cell 16 is for example of the Li-ion type.

Each cell 16 is prismatic in shape. Alternatively, each cell 16 is a pocket cell. In the remainder of the description, the faces of the cell 16 that are substantially parallel to the X-Y plane when the cells 16 are arranged in the housing 14 are referred to as horizontal faces, the faces of the cell 16 that are substantially parallel to the Y-Z plane when the cells 16 are arranged in the housing 14 are referred to as transverse faces, and the faces of the cell 16 that are substantially parallel to the X-Z plane when the cells 16 are arranged in the housing 14 are referred to as longitudinal faces.

The longitudinal, transverse and horizontal faces of the cells are substantially perpendicular to each other.

Each cell 16 is arranged in the interior volume 40 of the docking member 18, or one of the docking members 18 when the battery 12 has a plurality of docking members 18.

Each cell 16 has an exposed face 44, arranged opposite the opening 42. Thus, the opening 42 opens onto at least one exposed face 44 of each cell 16 arranged in the interior volume 40. The exposed face 44 contains electrodes 45 of the cell, which are thus accessible.

As shown in FIG. 1, the exposed face 44 corresponds for example to a horizontal face of the cell 16.

As shown in FIG. 2, the exposed face 44 is, for example, arranged opposite the upper part 26. In particular, the exposed face 44 is arranged opposite the upper plate 36. When the battery 12 comprises an intermediate plate 22, at least one cell 16 comprises, for example, an exposed face arranged opposite the intermediate plate 22.

The cooling circuit 21 comprises for example a plurality of conduits 46. The conduits 46 are intended to conduct a fluid, such as a heat transfer fluid, to cool the battery 12 and more particularly the electricity storage cells 16.

As can be seen in FIG. 2, the cooling circuit 21 is arranged in the interior volume 40. The cooling circuit 21 is arranged between the plurality of cells 16 and a side wall of the docking member 18. In particular, the cooling circuit 21 is arranged between the side face of at least one electricity storage cell 16 and the corresponding side wall of the docking member 18.

When the battery 12 has a plurality of docking members 18 extending in parallel, the side walls 43 of two adjacent docking members 18 are covered with sections of the cooling circuit 21, arranged astride these side walls, to extend into the interior volumes 40 of the two adjacent docking members 18.

The cooling circuit 21 extends, for example, on both sides of at least one electricity storage cell 16 and connects the cell 16 on both sides to the docking member. For example, the cooling circuit 21 holds at least one electricity storage cell 16 longitudinally in the docking member 18.

Each holding member 19 is shaped to hold at least one electricity storage cell 16 in the battery 12 and in particular to hold an electricity storage cell 16 in the docking member 18.

Each holding member 19, in some embodiments, comprises a support 48 and a locking element 50.

The support 48 is, for example, a member formed from thermoplastic resin. Alternatively, the support 48 is a member formed of any other plastic, or metal such as aluminium.

The locking element 50 is, in some embodiments, an element formed from a flexible material, i.e. a material that can be deformed, for example manually.

The locking element 50 is for example formed from an elastomer, for example rubber. Alternatively, the locking element 50 is made of thermoplastic.

In the example shown in FIGS. 1 to 3, the battery 12 comprises four different holding devices 19. In particular, the battery comprises a plurality of each of these different holding devices 19.

In particular, the battery 12 comprises at least one first holding member 52, at least one second holding member 54, at least one third holding member 56 and at least one fourth holding member 58.

The first holding member 52 is, for example, elongated and arranged transversely in the housing 14 so as to be parallel to at least one of the docking members 18.

The first holding member 52 comprises a first support 60 attached to the upper part 26 and a flexible first locking element 62 attached to the first support 60.

The first support 60 and the first locking element 62 are in accordance with the support 48 and locking element 50 as previously described.

The first support 60 forms for example a rail, for example a U-shaped rail. When the first support 60 forms a U-shaped rail, the base of the support is, for example, attached to the upper part 26 and the legs of the U extend towards the cells 16. For example, two separate first locking elements 62 are attached to the ends of the legs of the U-shaped profile.

Each first locking element 62 is for example in the form of an elongated cord. Each first locking element 62 extends between the first support 60 and at least one electricity storage cell 16, to lock said electricity storage cell 16 vertically in the housing 14. Each first locking element 62 is, in other words, configured to prevent movement of the cell 16 along the Z axis. Each first locking element 62 is then compressed between the electricity storage cell 16 and the first support 60. Two first locking elements 62 connect, for example, an electricity storage cell to a single support 48, or, as shown in FIG. 2, to two different supports 48.

Alternatively, each first bracket 60 is not attached to the upper part 26 but to the intermediate plate 22. In such a case, the intermediate plate 22 takes over the role of the upper part 26, with the first support 60 attached to the intermediate plate 22.

Alternatively, each first support 60 is not attached to the upper part 26 but to the docking member 18.

The second holding member 19 is, for example, elongated and arranged transversely in the housing 14 so as to be parallel to at least one docking member 18.

The second holding member 54 comprises a second support 64 and a second flexible locking element 66 attached to the second support 64.

The second support 64 and the second locking element 66 are in accordance with the support 48 and locking element 50 as previously described.

The second support 64 forms for example a rail, for example a U-shaped rail. When the second support 64 forms a U-shaped rail, the base of the support is, for example, attached to the upper part and the legs of the U extend towards the cells 16. For example, two separate second locking elements 66 are attached to the ends of the legs of the U-shaped profile.

Each second locking element 66 is for example in the form of an elongated cord.

Each second locking element 66 extends between the second support 64 and a side face of at least one electricity storage cell 16, to lock said electricity storage cell 16 longitudinally in the housing 14. Each second locking element 66 is, in other words, configured to prevent movement of the cell 16 along the X axis.

In particular, each second locking element 66 is engaged between the electricity storage cell 16 and the docking member 18, each second locking element 66 holding the electricity storage cell in position in the docking member 18. An electricity storage cell 16 is for example arranged between two second locking elements 66 along the longitudinal axis. Each second locking element 66 is then compressed between the electricity storage cell 16 and the corresponding side wall of the docking member 18.

Alternatively, each second bracket 64 is not attached to the upper part 26 but to the intermediate plate 22. In such a case, the intermediate plate 22 takes over the role of the upper part 26, with the first support 60 attached to the intermediate plate 22.

In one particular embodiment, the first support 60 and the second support 64 and/or the first locking element 62 and the second locking element 66 are integral.

The third holding member 56 comprises a third support 68 and a third holding element 70.

The third support 68 and the third locking element 70 are in accordance with the support 48 and locking element 50 as previously described.

The third support 68 is attached to the lower part 24. In particular, the third support 68 is attached to the lower edge 32. Alternatively, the third support 68 is attached to the upper part 26, or alternatively, the third support 68 is attached to the docking member 18.

In one particular embodiment, the third support 68 holds the ends of some of the docking members 18. In this embodiment, the third support 68 connects, for example, the docking members 18 to the lower part 24. The third locking element 70 extends between the third support 68 and the longitudinal face of at least one electricity storage cell 16, to lock said electricity storage cell 16 laterally in the housing. Each first locking element 70 is, in other words, configured to prevent movement of the cell 16 along the Y axis.

In particular, each third locking element 70 is compressed between the third support 68 and the longitudinal face of at least one cell 16. A plurality of cells 16 is stacked along the lateral direction Y and clamped between two third holding members 56.

In one particular embodiment, the third locking element 70 is wedge-shaped and is intended to be inserted between at least one cell 16 and the third support 68 to exert a holding force on the cell.

The fourth holding member 58 comprises a fourth support 72 and a fourth holding element 74.

The fourth support 72 is attached to the lower part 24. In particular, the fourth support 72 is attached to the lower edge 32. Alternatively, the fourth support 72 is attached to the upper part 26.

In one particular embodiment, notably illustrated in FIG. 1, the fourth support 72 holds the ends of some of the docking members 18. In this embodiment, the fourth support 72 connects the docking members 18 to the lower part 24.

The fourth locking element 74 extends between the longitudinal faces of two adjacent electricity storage cells 16, to lock said electricity storage cell 16 laterally in the housing 14. Each first locking element 74 is, in other words, configured to prevent movement of the cell 16 along the Y axis.

In one particular embodiment, the fourth locking element 74 is wedge-shaped and is intended to be inserted between at least two cells 16 to exert a holding force on the cells.

As illustrated in FIG. 1, in one particular embodiment the battery comprises a stacking region 76.

In the stacked region 76, the battery 12 comprises at least two cells 16 stacked one above the other in the Z direction. In particular, the cells 16 are stacked between the lower plate 30 and the upper plate 36.

According to such an embodiment, the battery 12 comprises an intermediate plate 22 as previously described.

The intermediate plate 22 is then arranged between the stacked electricity storage cells 16. In this embodiment, the intermediate plate 22 is comparable to a lower plate 30 as described above for the cell at the top of the stack, and to an upper plate 36 for the cell at the bottom of the stack.

The impact damper 23 has, as shown in FIG. 3, a plurality of cavities. The impact damper is configured to deform in the event of an impact, in particular to absorb an energy of the impact and to limit the deformation of the housing 14, in order to prevent damage to the electricity storage cells 16.

When the battery 12 comprises such an impact damper 23, the battery 12 includes reinforcing portions 78. The reinforcing portions 78 are intended to stiffen the housing 14.

The reinforcing portions 78 are arranged opposite the lower plate 30 and/or the upper plate 36 and/or the intermediate plate 22.

The impact damper 23 is connected to the housing opposite the lower plate 30 and/or the upper plate 36 and/or the intermediate plate 22. In particular, the impact damper 23 is connected to the housing by its reinforcing portions 78.

A battery in which each docking member 18 has an opening 42 to the interior space 40 can be advantageous as it reduces the production costs of such a battery 12 by lightening its structure. Such a battery 12 also makes it possible to limit the assembly steps of the battery 12 by directly installing the cells 16 in the battery without having to install them in a module.

The shape and material of the components used accentuate the cost and weight reduction benefits associated with the present disclosure.

The use of holding members 19 ensures the robustness of the battery by locking all degrees of freedom of the cells 16 in the housing 14, thus preventing their deterioration in the event of strong accelerations applied to the battery 12.

The position of the cooling circuit 21 relative to the electricity storage cells 16 can be advantageous for improving the cooling of said electricity storage cells 16.

The presence of an impact damper 23 and in particular the position of its connection to the housing 14 can be advantageous in limiting damage to the cells following any impact, thus making the battery 12 safer to use.

In a particular embodiment, the battery 12 comprises wedging elements, configured to hold the cells 16 along the transverse direction Y. The wedging elements are, for example, integral with the docking member 18 and extend between two adjacent cells 16. Such wedging elements can be advantageous in limiting the forces applied to the holding members 19 while ensuring that the cells 16 are held in the battery 12.

In the foregoing description, we consider a direct orthonormal basis (X, Y, Z).

The longitudinal direction X corresponds to the direction in which the battery is most elongated. The longitudinal direction X is oriented along the length of the battery. The longitudinal direction X corresponds for example to the front-rear direction of the vehicle when the battery is installed in the vehicle.

The transverse direction Y corresponds to the second direction in which the battery is most elongated. The transverse direction Y is oriented along the width of the battery. The transverse direction Y corresponds for example to the left-right direction of the vehicle when the battery is installed in the vehicle.

The elevation direction Z corresponds to the direction in which the battery is least elongated. The elevation direction Z is oriented according to the height of the battery. The elevation direction Z corresponds for example to the up-down direction of the vehicle when the battery is installed in the vehicle.

In the following, the term “longitudinally” refers to the longitudinal direction X, the term “laterally” refers to the lateral direction Y, and the term “vertically” refers to the elevation direction Z.

In alternative variants, the longitudinal direction X and the lateral direction Y can be interchanged, as can their orientation relative to the vehicle.

1. An electrical battery comprising:
a housing comprising a lower part, and an upper part,
a plurality of electricity storage cells, arranged in the housing and intended to together form a source of electrical energy for the battery, and
at least one docking member of the plurality of cells, each docking member defining an interior volume, each electricity storage cell being arranged in the interior volume and being attached to the housing by means of one of the or the docking member,
wherein each docking member extends transversely into the housing and covers at least one side face of each electricity storage cell, each docking member having an opening to the interior volume such that the opening opens onto an exposed face of each electricity storage cell arranged in the interior volume.

2. A battery according to claim 1, wherein the electrical battery is for a vehicle.

3. A battery according to claim 1, wherein the docking member is formed by a beam or profile having a U-shaped cross-section.

4. A battery according to claim 1, wherein the housing and/or the docking member are formed of thermoplastic or thermosetting resin.

5. A battery according to claim 4, wherein the thermoplastic or thermosetting resin is reinforced with chopped and/or continuous fibres.

6. A battery according to claim 1, wherein the battery comprises at least one holding member of at least one electricity storage cell in the docking member, the at least one holding member comprising at least one locking element.

7. A battery according to claim 6, comprising:
a first holding member comprising a first support attached to the upper part, and a flexible first locking element extending between the first support and the exposed face of at least one electricity storage cell, to lock said electricity storage cell vertically in the housing, and/or
a second holding member comprising a second support attached to the upper part, and a flexible second locking element extending between the second support and a side face of at least one electricity storage cell, to lock said electricity storage cell longitudinally in the housing, and/or
a third holding member comprising a third support attached to the lower part and/or to the docking member, and a third locking element extending between the third support and a longitudinal face of at least one electricity storage cell, the longitudinal face extending substantially perpendicularly to the exposed and side faces, to lock said electricity storage cell laterally in the housing, and/or
a fourth holding member comprising a fourth support attached to the lower part and/or to the docking member, and a fourth locking element extending between the longitudinal faces of two adjacent electricity storage cells, each longitudinal face extending substantially perpendicular to the exposed and side faces, to lock said electricity storage cells laterally.

8. A battery according to claim 1, wherein the battery comprises a cooling circuit arranged in the interior volume, between the side face of at least one electricity storage cell and the docking member.

9. A battery according to claim 1, wherein the battery comprises a reinforcing profile, the reinforcing profile connecting the docking member to the lower part of the housing and holding the docking member away from the lower part of the housing.

10. A battery according to claim 1, wherein the battery comprises a stacking region, at least two electricity storage cells being stacked between a lower plate of the lower part of the housing, and an upper plate of the upper part of the housing in the stacking region, the battery comprising at least one intermediate plate arranged between the stacked electricity storage cells.

11. A battery according to claim 10, wherein the battery comprises at least one impact damper arranged outside the housing, the impact damper being connected to the housing opposite the lower plate and/or the upper plate and/or the intermediate plate.

12. A vehicle comprising an electrical battery, wherein the electrical battery includes
a housing comprising a lower part, and an upper part,
a plurality of electricity storage cells, arranged in the housing and intended to together form a source of electrical energy for the battery, and
at least one docking member of the plurality of cells, each docking member defining an interior volume, each electricity storage cell being arranged in the interior volume and being attached to the housing by means of one of the or the docking member,
wherein each docking member extends transversely into the housing and covers at least one side face of each electricity storage cell, each docking member having an opening to the interior volume such that the opening opens onto an exposed face of each electricity storage cell arranged in the interior volume.
